(19) United States
(12) Patent Application Publication
(10) Pub. No.: US 2013/0085803 A1
(43) Pub. Date: Apr. 4, 2013

(54) BRAND ANALYSIS

(71) Applicants: Joseph L. Mauro, Jersey Shore, PA (US); John Tomko, Williamsport, PA (US); Zachary H. Wahl, Williamsport, PA (US)

(72) Inventors: Joseph L. Mauro, Jersey Shore, PA (US); John Tomko, Williamsport, PA (US); Zachary H. Wahl, Williamsport, PA (US)

(73) Assignee: AdTrak360, Williamsport, PA (US)

(21) Appl. No.: 13/252,002

(22) Filed: Oct. 3, 2011

(51) Int. Cl. G06Q 30/02

(52) U.S. Cl. 705/7.29

(57) ABSTRACT

A system provides an analysis of a the strength or weakness of a brand as reflected in both on-line and off-line media. The system automatically retrieves data relating to a particular brand from a plurality of different media channels which may reflect inputs received from the various media channels, perhaps in response to advertisement campaigns. The system generates a score for each media channel which reflects a comparison of the inputs that were received for the brand relative to other similarly situated entities. An aggregate score is generated from the scores that have been generated for the various media channels. Scores and analysis reflecting a relative strength and weakness for a brand are presented.

### BACKGROUND

A multitude of communication media or channels are available to individuals and businesses. For example, in addition to traditional media such as newspapers, magazines, and printed periodicals, individuals and businesses now may communicate using the world wide web (“the web”), various messaging technologies such as email and instant messaging, telephone, and social media technologies such as twitter and blogs, to name a few.

The explosion in communication media/channels has been a boon for all types of expression, both commercial and non-commercial. Individuals may now receive information using any and all of the available communication channels, and may respond to and/or express their opinions in response to the information received. The commercial application of these technologies has not been lost on businesses as they have sought to use the new technologies for advertisement and marketing. For example, while an advertiser may run advertisements in a traditional off-line media such as papers and broadcast television, they may also simultaneously run advertisements in on-line media such as the web.

While businesses have attempted to seize upon the advertising opportunities presented by these new technologies, businesses are also faced with the practical reality that is difficult to know how their businesses and brands are perceived in the marketplace given the wide assortment of media channels where customers and potential customers take actions and express their opinions.

### SUMMARY

Applicants disclose systems and methods for quantifying the strength or weakness of a business's brand as reflected in both on-line media, i.e., communicated via an Internet communications link, and off-line media, i.e., not communicated via an Internet communications link. On-line media often involves media that is automated and electronically interactive. Websites, mobile websites, social media, instant messaging and similar messaging types are all electronically interactive media that may be considered on-line media. Users may employ the disclosed systems to obtain a score that is a quantifiable representation of the strength or weakness of a business's brand as reflected in selected media feeds or channels.

In an example embodiment, the disclosed system receives data relating to a particular brand from a plurality of media types/channels. The brand may be a company name, a product name, or any other thing for which the user wishes to measure sentiment as reflected in various media. The media types/channels from which the data is received may be identified by the user and may be any types/channels. For example, data relating to a brand may be received from a web source such as, for example, a company's web page or special landing page that was established for a particular brand. Data may also be received that reflects telephone calls that were made to a particular telephone number relating to the brand. For instance, a telephone number may be established to receive calls relating to a particular promotion. Still further, the data may reflect email that is relevant to the particular brand, such as email received in response to a marketing campaign.

For each of the media channels, a score is developed that reflects the strength or weakness of the brand as reflected by the data from that particular media channel. For example, if data was received reflecting inputs at a website, a score for the brand as reflected by the website is determined. Similarly, if data was received reflecting telephone conversations made to a particular telephone number, a score for the brand as reflected in the telephone calls is made. In an exemplary embodiment, the scores may be generated from a comparison of the data received from the particular media source to historical data reflecting data for similarly situated businesses. The system may then generate an aggregate score for the strength or weakness of the brand as reflected in the scores for the various media channels.

In an example embodiment, the disclosed systems may subsequently analyze the brand scores. The analysis may be performed for scores for the individual media channels as well as for the aggregate score. In an example scenario, the analysis may involve comparing the derived scores with scores for other brands. For example, the system may compare the scores to those derived for similarly sized businesses, businesses that compete in the same industry, and/or businesses that share some other characteristic such as geographic location. The analysis may involve comparing the scores to historical data for scores derived from a particular media feed. Still further, the analysis may involve comparing the scores to scores that are considered standard for a particular industry.

According to another aspect of the disclosed systems and methods, analysis may be performed against the particular data items that were received in connection with each media channel. Accordingly, in an example scenario where the media channel is a web page, the data received regarding the web page may include, for example, unique visitors, average page views, new visitors, average time on the site. The disclosed system may analyze the particular values for such data items by comparing the data values to similar data values for other brands or companies. By way of further example, if the media channel is a social media service such as, for example, Facebook, the data that is received and which may be analyzed may include, for example, data relating to social strength, social sentiment, social passion, and/or social reach. The values for such data items received for a particular brand may be compared to values for the same data items associated with similarly situated brands.

According to another aspect of the potential embodiments, the analysis performed in the system may involve comparing the derived scores to benchmarks that had been set by the user. For example, the system may receive a benchmark value from a user that represents the minimum score that the user wishes to receive for a particular media channel. As scores are determined, the system may check for any benchmarks that may have been established and generate a notification if the benchmark has or has not not been satisfied. Such benchmarks may be established and analyzed for scores and/or for particular data items that are received for media channels.

According to still another aspect of the potential embodiments, the analysis performed in the system may involve providing suggestions or tips in view of the derived score or the value of the received data. For example, if a score is determined by the system to be low or to fall below a predetermined value, the system refers to a rule base that contains suggest actions that might result in an improvement to the score. In an example scenario, the score derived by the system for a particular brand may be below a desired benchmark. The system may refer to a rule base to derive a tip for the particular brand. For example, the rule base may indicate that companies in a particular industry have had success with running email campaigns focused at a particular demographic. The system may communicate a corresponding suggestion to the brand owner.

According to another aspect of the disclosed embodiments, the system may provide a user interface that reflects updates to data that is received from the various media channels. For example, where the media channel is a Facebook page relating to a particular brand, the system may provide on the user interface data reflecting compilations of the following: whether a message has been written to the Facebook wall; whether a comment has been made; whether a user has identified that they “like” the brand associated with the Facebook page; whether someone has “checked-in” to the Facebook page; and whether someone has tagged the particular Facebook page. As new data is received corresponding to the particular media channel, i.e., the particular Facebook page, the displayed data is updated to reflect the recently received data.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

FIG. 1 is a block diagram of an illustrative computing arrangement in which aspects of the subject matter described herein may be implemented.

FIG. 2 is a block diagram illustrating functional components of an illustrative computing arrangement.

FIG. 3 is a block diagram depicting processing in an illustrative system for brand analysis.

FIGS. 4A-4I depict example user interfaces with representative data that may be generated in an illustrative system for brand analysis.

FIG. 5 is a block diagram of a computing environment with which aspects of the subject matter described herein may be deployed.

### DETAILED DESCRIPTION OF ILLUSTRATIVE EMBODIMENTS

Overview

A multitude of communication media or channels are available to individuals and businesses. For example, in addition to traditional media such as newspapers, magazines, and printed periodicals, individuals and businesses now may communicate using the world wide web (“the web”), various messaging technologies such as email and instant messaging, telephone, and social media technologies such as twitter and blogs, to name a few. While businesses have attempted to seize upon the advertising opportunities presented by these new technologies provide, businesses are also faced with the practical reality that is difficult to know how their businesses and brands are perceived in the marketplace given the wide assortment of media channels where customers and potential customers take actions and express their opinions.

Applicants disclose systems and methods for analyzing brand sentiment as indicated by a plurality of media channels. A brand may be a name, term, design, symbol, or any other feature that identifies one seller's good or service as distinct from those of other sellers. The sum of all points of contact with the brand may be referred to as the brand experience. The customers' ability to recall and recognize the brand under different conditions may be referred to as brand awareness. The systems and methods disclosed herein measure all aspects of the brand, including but not limited to brand awareness and brand experience with emphasis on email, social, calls, web, mobile, financial, point-of-sale, demographic, behavioral, and psychological data. Systems and methods are described herein for measuring brand awareness using various customer interactions relating to a brand including, for example, received emails, received telephone calls, web interactions, mobile applications, social media applications, etc. It should be appreciated that any on-line or off-line customer interactions may be used per the described systems and methods to measure brand awareness. Data relating to a particular brand is received from a plurality of media types/channels. For example, data may be received that has been derived from a particular web site and/or from telephone call conversations. A score reflecting the strength or weakness of the brand is developed for each of the media channels. An aggregate or composite score is derived from the individual scores. Thereafter, the system performs various analyses of the scores including, for example, comparing the scores to similar firms and or predetermined benchmarks. The analysis may also involve identifying suggestions for improving the score.

Example Computing Arrangement

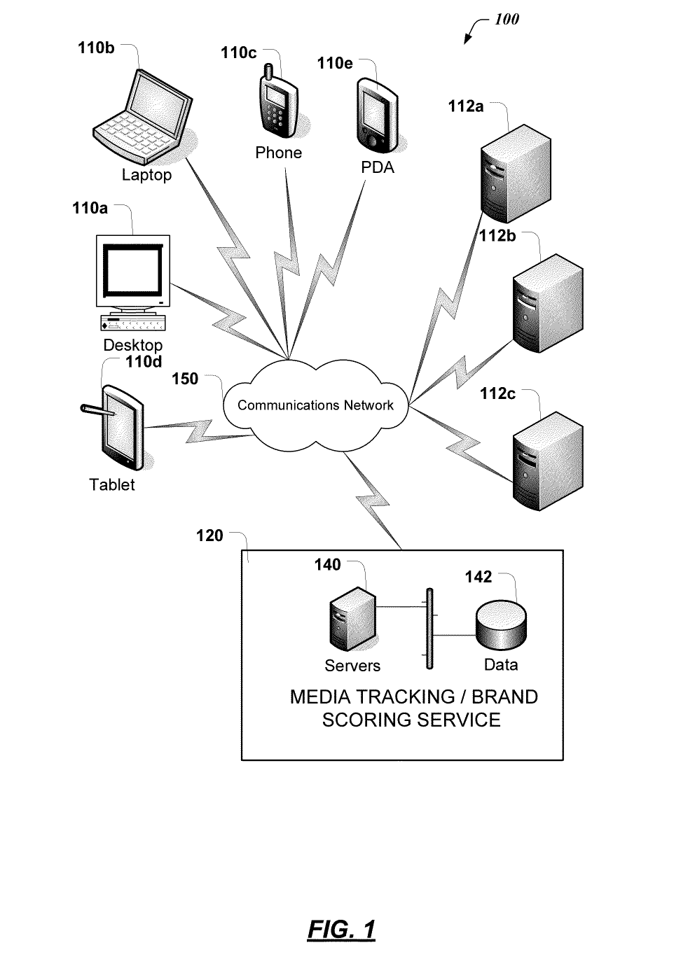

FIG. 1 illustrates an exemplary computing network 100 suitable for brand analysis. Brand scoring service 120 offers a number of different functions including, for example, receiving data relating to brands from a plurality of different media channels, deriving scores for brands based upon the input data, and deriving suggestions in response to the derived scores. It should be appreciated that brand scoring service 120 may also be adapted to provide functionality for tracking media advertisement as described in U.S. patent application Ser. No. 13/188,84 titled “Advertising Media Tracking” which was filed on Jul. 22, 2011, the contents of which are hereby incorporated by reference in their entirety. In that application a media tracking service is described that offers a number of different functions including, for example, defining advertising campaigns, assigning tracking identifiers to advertisements, receiving inputs generated by the advertisements, correlating the inputs with the advertisements using the tracking identifiers, and presenting data regarding the effectiveness of the various advertisements. All of the various inputs that are described in U.S. patent application Ser. No. 13/188,84 titled “Advertising Media Tracking,” as having been received in response to advertising campaigns may also be used as inputs in connection with developing scores for a brand. Accordingly, inputs such as, for example, emails and telephone calls that may be received in response to a particular broadcast media advertisement (radio, television, etc.) may be also be received and processed in connection with deriving a score as described herein. Likewise, inputs such as web link click throughs or landing page accesses that are associated with a particular advertising campaign may be web channels that are received into the system described herein for performing brand analysis.

Users employ computing devices 110a-e to interface with brand scoring service 120 via communications network 150. Computing devices 110a-e may be used to interface with brand scoring service 120 in order to identify in the system the media channels from which data is to be received as well as to identify any particular analysis that is requested including any benchmarks and/or notifications that should be implemented by the system. Users may also use devices such as 110a-e to access output including web pages and reports that provide feedback regarding scores for brands and related analysis.

In an exemplary environment, brand scoring service 120 provides various functionalities associated with generating scores reflecting strengths and/or weaknesses of brands. For example, brand scoring service 120 may receive inputs defining requests for scoring a brand, receive data from media channels in connection with generating scores, and generating feedback information regarding scores and related analysis. The brand scoring functionality as described herein is performed on computing servers 140 which communicate with data stores 142, which may be accessed locally or remotely. Data stores 142 maintain any data that may be needed to support the functionality described herein. For example, data stores 142 may comprise data regarding brand scoring requests including any definitions for the particular media channels from which data should be received and analyzed as well as any analysis that should be performed, data from media channels that are received in connection with the scoring, and data resulting from any analysis of the received data including. Computing servers 140 provide functionality to receive inputs defining scoring requests, to receive data from media channels, to analyze the data, and to communicate feedback including scores and related analysis. Any number of servers 140 and data stores 142 may be used to provide a media tracking service as described herein.

Brand scoring service 120 is accessible via communications network 150. Communications network 150 may be any type of network that is suitable for providing communications between computing devices 110a-e and service 120. Moreover, communications network 150 may comprise a combination of discrete networks which may use different technologies. For example, communications network 150 may comprise local area networks (LANs), wide area networks (WAN's), cellular networks, or combinations thereof Communications network 150 may comprise wireless, wireline, or combination thereof In an exemplary embodiment, communications network 150 comprises the Internet and may additionally comprise any networks adapted to communicate with the Internet. In one exemplary embodiment, communications network 150 may comprise a network that enables passengers on a commercial airline to communicate with servers 140.

Persons that wish to request brand scoring analysis in the service 120 and to access data regarding the requested scoring may do so using computing devices 110a-e. Computing devices 110a-e may be any type of device that is operable to communicate with service 120. For example, computing devices 110a-e may be desktop computers, laptop computers, wireless phones, personal digital assistants, tablet computers, media players, etc. While only five devices are illustrated in FIG. 1, it is understood that service 120 may be accessed via any number of computing devices 110a-e.

Data relating to requested brand scoring may be received from media channel servers 112a-c. Media channel servers 112a-c contain and/or provide access to data that may be employed in generating a brand score. For example, media channel servers 112a-c may provide access to website data, social media data, call tracking data, or any other data that may be used to generate a score. The data may be data that has been generated as a result of a particular advertisement that had been run or is being run. For example, the media channel may reflect data relating to an email advertising campaign, a website, or Facebook page. U.S. patent application Ser. No. 13/188,84 titled “Advertising Media Tracking,” the contents of which are hereby incorporated by reference in their entirety, may provide further description of advertising campaigns and related data that may be suitable for receipt via media channel servers 112a-c.

Computing arrangement 100 may employ a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computing device, such as one of devices 110a-e that accesses shared network resources provided by another computer (i.e., a server). A server, such as device 140, is typically a remote computer system accessible over a remote network such as the Internet. The client process may be active in a first computer system, and the server process may be active in a second computer system, communicating with one another over a communications medium and allowing multiple clients to take advantage of the information-gathering capabilities of the server.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client computers to each other. Communication among computing devices is provided over a communications medium. In particular, the client and server may be coupled to one another via TCP/IP connections for high-capacity communication.

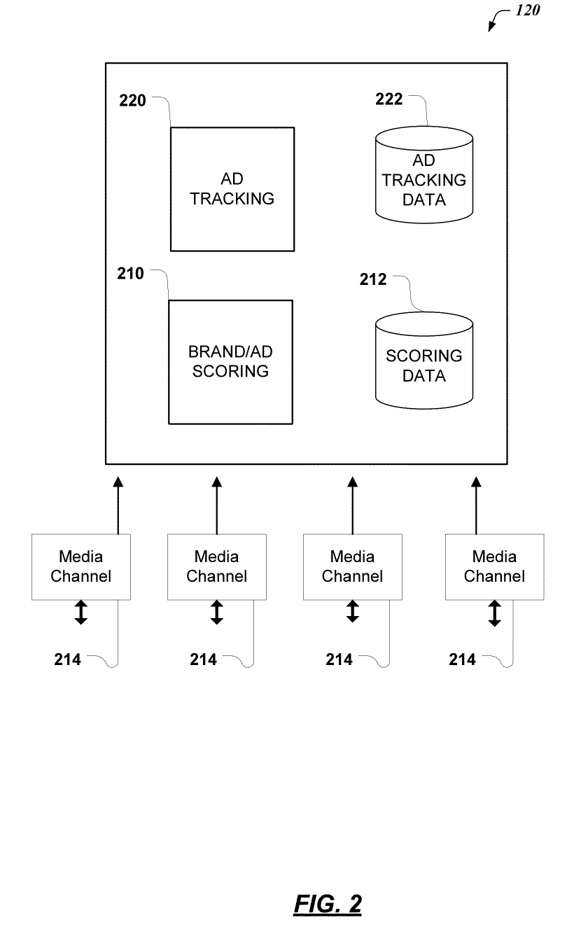

FIG. 2 depicts a block diagram illustrating exemplary logical components of an illustrative service 120 for brand scoring and analysis. In the example embodiment of FIG. 2, server 120 comprises brand scoring functionality 210, scoring data 212, and interfaces 214 to media channel data from which scores are derived. Brand scoring functionality 210 is responsible for providing a user interface that allows users to access the service and define a request to have a particular brand scored. For example, functionality 210 may allow users to specify information relevant to the brand that is to be scored. The functionality may allow for entry of information about the brand, the size of the relevant organization, the industry in which the organization operates, competitor information, the source of data to be considered in the scoring, relevant login credentials for the data sources, the time period over which the scoring is to be implemented, and any benchmarks that are to be implemented in the

Brand scoring functionality 210 is likewise responsible for coordinating the receipt of relevant data via media channels 214. Accordingly, functionality 210 may use application programming interfaces to access remote data sources from which scoring data is to be accessed. This may involve using login credentials that have been received from the user to access and request from the relevant media channel the relevant data.

Brand scoring functionality 210 may also coordinate storing received data in database 212. Furthermore, brand scoring functionality 210 is responsible for analyzing the received data to derive scores for each of the media channels, generate an aggregate score, and perform any related analysis such as comparing the scores or component data on which the cores are based to data for similarly situated organizations and/or benchmarks. Still further, brand scoring functionality 210 includes the capability to present scores and the results of analysis. For example, the scoring results may be presented on a website or communicated through any other electronic communication medium.

Scoring data database 212 provides a repository for all data that may be received and generated in connection with preparing and presenting brand scores and related analysis. For example, the database may comprise data reflecting brand scoring requests that have been received and all information needed to perform the requested scoring. The information may specify the media channels from which data is to be retrieved along with any login credentials for the media channels. Database 212 may further include the data that is actually received from the various media channels. For example, if data is received from Facebook, a particular web site, or relate to received phone conversations, the information regarding those sources is stored in database 212. Still further, the results of any analysis such as scores, benchmark analysis, etc., may be stored in database 212. If system 120 provides feedback in the form of tips as to what actions may be taken to improve scores, that information may be stored in database 212 and may be referred to as a rule base.

Media channel interfaces 214 reflect that service 120 may communicate with any number of external systems that provide data relevant data upon which scores may be generated. Interfaces 214 may be specialized to interface with a particular third party data source such as anyone of the numerous social media sites from which data may be gathered. For example, the interfaces may be specialized to interface using particular application programming interfaces or automated page scraping methodologies that are relevant to the media channel. Furthermore, media channel interfaces 214 may be adapted to receive any type of data reflecting both online and offline media types. Accordingly, the media channel interfaces may be adapted, for example, to receive input regarding actions such as emails and phone calls that were taken in response to a broadcast media (radio, television, cable, etc.) advertisement. Likewise, the media channel interfaces may be adapted to receive input relating to on-line media such as, for example, web page accesses, web link click-throughs, Facebook friends, etc., some of which perhaps are tied to a particular advertisement campaign.

Brand scoring service 120 may further comprise functionality 220 and data 222 that is used to perform ad tracking features as is described in U.S. patent application Ser. No. 13/188,84 titled “Advertising Media Tracking” which was filed on Jul. 22, 2011, the contents of which are hereby incorporated by reference in their entirety. It should be appreciated that while data 222 is designated as relating to ad tracking, all or a portion of the same data may be comprised in scoring data 212 and used by brand scoring functionality 210.

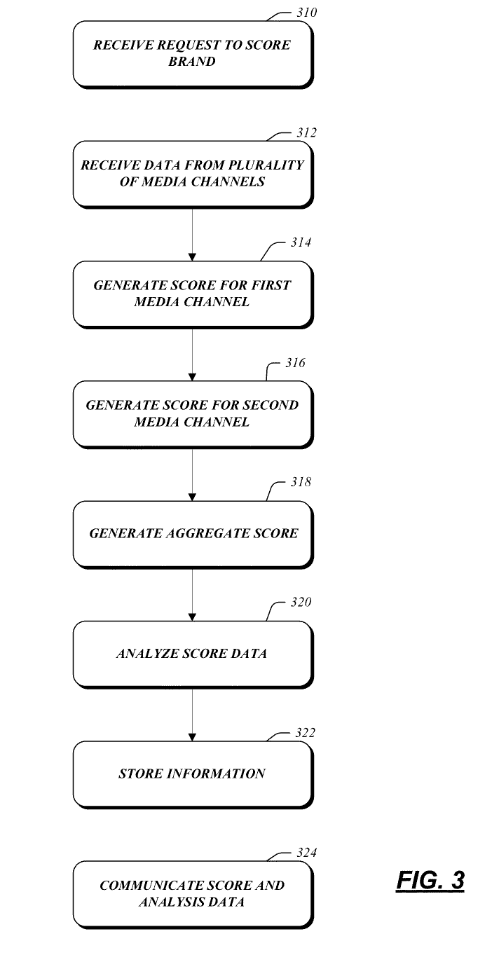

FIG. 3 depicts a flow chart of example processing performed in brand scoring service 120. As shown, at block 310, brand scoring service 120 receives a request to perform a brand score analysis. Through a series of inputs, which may be via a graphical user interface, service receives information needed to define and implement a desired brand score analysis. For example, service 120 may receive information about the particular brand including, for example, the name of the company, product, service, or other item for which there is interest in evaluating a brand. Information relevant to the particular media channels from which data is to be retrieved/received is also received by service 120. For example, inputs may be received specifying that information from particular websites, social media services, landing pages, or any other data source are to be considered in generating a score. The identified web channels may correspond to advertisements or marketing efforts that are being run. For example, a media channel may relate to telephone calls that have been received in response to a radio advertisement that is currently running. The media channel may relate to an email campaign. The information supplied by the user may include login credentials (identification and password) that are used to access a particular media source. Further, the inputs may specify the scope of the analysis (time and frequency of data requests) and any benchmarks or other information that is to be used in analyzing the received media information. The information that is received at block 310 and may be stored in a database such as, for example database 142.

At step 312, data is received from a plurality of media channels. As a preliminary matter when discussing receipt of data in brand scoring service 120, it is useful to understand that concept of a metric and how it may be used in an example embodiment. Service 120 may use the concept of a metric as an arbitrary value with which calculations may be performed and comparisons may be made. For a specific example, service 120 may track the number of visitors to a website. The methodology of performing this tracking depends upon the requirements established in the service 120. There may be an interest to know how many visitors there are per week, per day, per hour, etc. Service 120 must therefore collect data at appropriate intervals such as, for example, on a daily basis so as to comply with the metrics to be used by service 120 in scoring. In short, a metric is a value upon which a comparison can be based.

In an example embodiment, brand scoring service 120 represents metrics in a database and stores the relevant data therein. For example, service 120 may represent metrics in the system using a database table comprising the following fields: ID—a unique database identifier; Metric Definition ID—the type of the metric; Provider Account ID—the source of the data; Time Unit ID—where along in a campaign the data was retrieved; Date/Time—when the data was retrieved; and Value—the numeric value of the metric. In an example embodiment, the metric table does not employ the concept of units. Metrics are compared to other metrics with the same metric definition ID. Since the values are always flat (not logarithmic or exponential), data can be compared without needing units. Units are in fact implied by the metric definition.

Referring to the database fields that may be used to store metric data, a metric definition specifies what a metric means. It has a human-readable name, such as Visitors, and determines whether higher values are a good or bad thing (open rate vs. unsubscribe rate). Good metrics are called positive and bad metrics are called negative.

A provider as used in the system is a source of data. A particular company's Google Analytics account may be considered a provider account. Every metric is associated with exactly one provider account. Multiple providers can be a source of the same metric (MailChimp open rates vs. VerticalResponse open rates) and so providers can be configured with which metrics they provide. This eventually allows metrics to be compared by metric definition, rather than by provider—a much larger pool of metrics. In an example embodiment, brand scoring service 120 doesn't prohibit using multiple providers for the same category of service; for instance, it doesn't limit a user to a single email provider. They can have multiples or none at all.

Most data is compared historically by seeing how a metric performed today versus previous days. However, some data cannot be compared so linearly. For example, email campaigns have a short lifetime and the more up-to-date the data provided to service 120, the more meaningful the service is to a user. However, comparing a new campaign to a completed campaign would typically result in a poor score. Accordingly, it makes logical sense to compare how a brand is perceived at a particular point during a campaign to how the brand was perceived during the same time in other campaigns. Email campaigns follow a schedule, where each occurrence during that schedule is referred to as a time unit. In an example embodiment of service 120, data may be retrieved for an email campaign on the 1st, 2nd, 4th, 8th and 12th hour and then performed at the end of each day, for a total of one week. Metrics that do not need hour-by-hour comparisons may ignore the time unit field. In an example embodiment, service 120 may treat non-campaign metrics as campaign metrics where there is just one time unit and every metric belongs to a different campaign.

Given the concept of a metric and how it might be used by service 120, there are any number of media channels that may be accessed or from which data may be retrieved. The media channels that may be accessed may be any that are accessible to service 120 including both those that are on-line such as web pages and social media services as well as those that are not on-line such as telephone call responses to a radio, paper, and/or television add. An exemplary list of media channels that might be accessed include the following: web pages; social media services; call tracking; email; landing page analytics; news media, mobile applications; financial; customer relationship management tools; point-of-sale systems; transactional data; and cable/broadcast media feeds.

Brand scoring service may use any methodology that is suitable for receiving and/or retrieving media channel data. For example, in many instances, media channels are accessed using an application programming interface (API). Generally, a separate API is used to retrieve raw data from each particular media channel or provider. This is necessary as each provider or media channel has different requirements for their APIs (such as credentials) and may employ different technologies for accessing the data. Because media channels require login credentials to access their data, users are required to provide any relevant login credential information when they create a request in the system to perform scoring analysis. The login credentials may includes user names, passwords, API keys, etc., and might even require a manual effort on our or the user's part.

The receipt and processing of data is also complicated by the fact that providers in the same category often provide different information. For instance, one email provider may provide forward rate and another may instead provide unsubscribe rate. Brand scoring service 120 cannot require that all providers share the same metrics; it also cannot take the least common denominator because it would limit the accuracy of the calculations. The general philosophy employed in an example embodiment of service 120 is to utilize whatever is available in order to generate the most accurate score possible.

In some instances, media channels provide data in a format that must be processed upon receipt in order to make use of the data. For example, a media channel may return data that is lumped together. For instance, it is common for email providers to return a single record holding the number of emails sent, opens, clicks, forwards and unsubscribers. Each of these values may be used to generate a metric (5 in all, in this example). In an example embodiment, brand scoring service 120 creates a layer that takes raw metrics, such as total emails opened, and converts them into the desired metrics, such as open rate (emails opened/emails sent). In an example embodiment, database 142 may be implemented such that the mapping process from raw metrics to the desired metric can be automated. Since each provider does things slightly differently, there is always some effort required bridging the provider-specific code to the more general-purpose, automated code.

How metrics are stored by service 120 partly depends on the type of the metric. Most metrics are retrieved on a daily basis and stored with no time unit. Advertising campaign-based metrics run whenever the next scheduled time unit occurs for the advertisement—that time unit is passed along to the database. It is worth noting that service 120 may gather more than just metrics. For instance, new campaigns and all of their associated data may be requested and received as well.

In an example embodiment, service 120 employs a mining service in order to coordinate retrieving data for potentially thousands of providers. The mining service, which may be a Windows service, may use task parallelization, queuing, and scheduler in order to manage workload. Tasks that have finished running are typically automatically rescheduled to run again. For daily tasks, this means in 24 hours. For campaign tasks, this means at the next time unit. Since there are limited resources available (such as database and network connections), the service is configured to only run a limited number of tasks at a time. If a task fails, it is not immediately re-run, in order to prevent quickly reoccurring errors. Errors are reported to the event viewer and the provider account is updated on the database to reflect that an error occurred. The last time a miner runs successfully is stored on the database. For daily tasks, the next time a task runs, it will attempt to retrieve data that has been generated since the last successful run. For campaign tasks, the data is simply forfeited, except for the final time unit (the campaign summary).

Referring back FIG. 3, and, in particular block 314, service 120 uses the received data for a first media source or channel to generate a score for the first media source or channel. At step 316, service 120 uses the received data for a second media source or channel to generate a score for the second media source or channel. While FIG. 3 depicts two media channels for which scores are generated, it should be appreciated that scores may be derived for any number of media channels. Furthermore, it should be appreciated that the media channels may include both on-line and off-line media sources such as radio, print, and television.

Generally, service 120 generates scores by comparing received values to those of similar brands and/or to expected values. For instance, a score may be calculated by comparing metric values over time (historic comparison) and by comparing metric values to those values belonging to other, related brands. Accordingly, scoring frequently involves grouping the appropriate data or metrics so as to be available for comparison. A brand, which may be a company, for instance, can be related by industry, annual income, number of employees and location. In one embodiment, brand scoring service allows for relating brands based upon ranges. For instance, a brand that is being scored may be related to brands within a 50 mile radius, a 100 mile radius or only to companies with the same zip code. By way of further example, a brand that is being scored might be related to other companies whose annual income is within $50,000 a year.

A single brand that is the subject of scoring analysis may have multiple media channels that are relevant and that need to be processed prior to comparison. Further, each media channel may comprise multiple data items or metrics. Media channels in the same category can support different metric types. In order to perform meaningful comparisons, only the metrics under the related channels or accounts with the same metrics definitions may be retrieved. This avoids retrieving data that wouldn't be used in the calculation. For the same reason, only metrics in the same time units may be retrieved.

Data may have been retrieved for a given date and time range. In an example embodiment, the calculation may use data from within the last 30 days when calculating the brand scores. If a metric falls out of this range, it no longer contributes to the calculation. In an example embodiment, users can request to see a calculation performed going further back than 30 days, but such a calculation may not be considered their official brand score.

In an example embodiment of brand scoring service 120, a score is calculated including all comparison types—both historical and relative to other companies. Service 120 may allow users to optionally see only the portion of the score based upon historical comparisons or comparisons within the industry. In one embodiment, service 120 allows users to manually specify comparison ranges as well.

Once the relevant data has been gathered and grouped, comparisons may be made for purposes of scoring. Scores are generally calculated in terms of percentiles. Percentiles are useful because they prevent rapid changes in metric values from quickly changing the score. For instance, if the number of web visitors doubles overnight, it doesn't result in an immediate doubling of the score. Also, if most of the values fall around or near the same value, the score normalizes itself out over time naturally. Furthermore, since typically metrics from the past 30 days are used in the calculation, it will start to penalize clients whose scores quickly went up and then started to plateau, since the lower scores from early on fall out of range.

The percentile may be calculated by sorting individual metric data by date and time and then seeing how a value compares to previous values. For campaign metrics, the time portion of the date is ignored once the data is sorted. Since only metrics with the same time units are compared to each other, where they appear within the same day is irrelevant. In an example embodiment, graphs are displayed with one day increments in order to prevent too many data points appearing in close vicinity.

In an example embodiment, service 120 calculates historic scores not only for the particular brand being considered, but for all brands. These are tracked throughout the calculation and are later used to display a value relative to the industry standards. In this context, the industry refers to other brands that are being scored in service 120. For the other comparisons, percentiles are calculated by comparing the account's metric values to the related accounts' metric values.

The historic comparisons and other scores may not be combined until later in the analysis. In reality, these scores may not be combined until the final steps in the calculation. Nevertheless, historic scores are calculated for a media channel and the related media channels, and the comparison scores are for the particular media channel.

In some instances, a brand, such as that for a corporation may be multi-leveled with multiple divisions or components to a corporation. Each level of the organization may contribute to the strength or weakness of the overall brand. In an example embodiment, service 120 employs a tree structure internally in order to address this complexity. For example, each brand may be associated with a tree structure that is composed of nodes. Each node can represent a metric, a media channel or data provider, a category (email, call, media, web or social) or the brand itself. The system also supports arbitrary nodes, for additional organization. A metric node's score is calculated by performing the percentile calculations. The score for all other nodes are made up by aggregating the child nodes' scores.

The system supports corporate divisions by allowing trees to be composed of other brand's trees. In this case, a corporation's score is the aggregated score of all of its branches' scores. In fact, trees can be configured arbitrarily to support any type of hierarchical structure. This feature allows for supporting franchise organizations and multi-location companies.

The structure of a brand's tree can change over time. For instance, a user might decide to start tracking metrics for another provider months after he or she created his or her account. Additionally, metrics for an existing provider may not exist for every day due to an error or a server being down for maintenance. Because of this, nodes in the tree may not contribute to the calculation every day. If they did, the overall score would appear to be lower, since a zero would be averaged in. In order to prevent this, the system makes sure that nodes with no contribution are ignored (or, in some cases, using a substitute score).

Referring back to FIG. 3, at block 318, service 120 uses the scores that have been generated for the various media channels to aggregate the scores into a composite score. The aggregate score provides an overall score for the particular brand. In an example embodiment, service 120 creates an aggregate by combining the scores for all metric nodes in the relevant tree. The total possible score is the maximum score minus the minimum score. In an example embodiment, the minimum score is 300 and the maximum score is 850, with a total range of 550 points. In another embodiment, the overall score may be the average of the metric scores times 550, plus the minimum score. Unfortunately, simply taking the average does not always provide a useful result. For one, not all metrics may contribute on any given day. Perhaps no media channel or provider is configured or an error occurred which prevent metrics from being retrieved. Perhaps, over time, the user added new media channels or providers and so there isn't anything historically against which to compare.

Assuming that a tree-like structure has been used to represent data relating to a score, an individual node on the tree can be assigned a weight. By default, all nodes have the same weight of one. This weight affects the weights of all of its descendant nodes. The parent's score is also affected by the weight of its children. When combining the scores of the children, bigger weights will cause those child nodes to have a larger influence over the score.

A node is assigned a share ratio (its share of the overall score). It is the combination of its parents' share ratio and its weight compared to those of its siblings. A node's weight ratio is its weight divided by the total weight of the nodes under its parent. Since a node may not contribute on any given day, the weight ratio is sensitive to time.

The use of the above structure may have particular implications. Firstly, metrics that are added later on will not affect older scores, thus making historic scores, somewhat, fixed. Secondly, extra effort must be taken to fill in gaps. Imagine that for one day only a small percent of the metrics were available. It would be misleading to base the entire score off of a few metrics when there are usually many more. Another common scenario is that throughout any given day, more metrics become available. If the score was based entirely on what had been seen thus far, the score could be greatly misleading. It could be late in the day before the score was an accurate representation, only to start all over again the next day.

In order to address such circumstances, in an example embodiment, service 120 carries scores forward to fill in gaps. In another embodiment of service 120, an average score may be used to fill in for gaps, although such a practice may cause scores to jump around wildly. As soon as a metric has a value, that value is carried forward until another value is encountered, which is then carried forward, and so on, until every day in the calculation range is filled. The share ratio of each node can then be accurately and simply determined by ignoring nodes whose metric values did not exist for a given day.

In embodiments wherein scores are carried forward due to a lack of new data, a user might be tempted to purposely invalidate their provider credentials once their score becomes high. The reasoning behind such a strategy is that high score would be carried forward for weeks at a time. However, since the calculation is based on the previous 30 days, eventually there wouldn't be any scores to carry forward. Ultimately, this would result in their score being meaningless. Users might also attempt to correct credentials with a service, and thereby provide service 120 with access to the service, only on those days that their scores are higher. Such a scenario is addressed by service 120 due to the fact that the service will attempt to retrieve data it failed to retrieve earlier. In this way, the missing data would eventually be brought in. This discussion is important because eventually companies may wish to use their brand score to market their brands.

Throughout most of the calculation, only metric scores, simple percentages, are used. It is only during the last few steps in the calculation that those percentages are applied to the node's share ratios or the 550. This works because of the distributive property. This is a useful technique because we can generate a score between 300 and 850 for any node in the tree, not just the top-most node. More importantly, this allows us to hold off performing any unnecessary calculations. In some cases, only a small portion of a tree has its scores displayed on the screen. However, since scores bubble their way up the tree from the bottom, the data must be available at every node in the tree. Avoiding unnecessary calculations helps to boost performance.

As the last part of the calculation, the scores for the metric nodes are multiplied by the 550, for each date in the calculation range. If only a single metric node made up the tree, the calculation would be almost done. Normally, however, scores must be aggregated from the bottom up. This is done simply by multiplying the nodes' scores, share ratios and the 550 to generate each node's contribution. The sum of the contributions and the minimum score (300) is then the final score.

This calculation works regardless of whether service 120 is calculating the overall score for an account or any other node in the tree. Accordingly, each node that is displayed to the user will have a score between 300 and 850. This can easily be changed by changing the minimum and maximum scores (say between 0 and 100). Users may be confused at times because the average of a node's children's scores will not always equal the parent's score. This happens because metrics may not exist on certain days, especially when introducing new providers. In these cases, one child may have more influence over the score simply because it has been around longer.

In an example embodiment, a metric's score is the average of the historic score and the comparison scores. Each comparison type (historic, industry, size of company, annual income, etc.) can have a weight applied to it. This allows for changing a particular comparison's influence dynamically. For instance, we might find that historic scores play a bigger role in an account's score than, say, the industry comparison.

As discussed below, service 120 provides various data relating to scores via a user interface. In some circumstances, an average score may be presented. This allows the user to see how their company is performing compared to related customers. This average score is calculated by taking the average of the historic scores for the related accounts. This average includes the account's data, as well, since the account contributes to the industry standard. Again, industry in this context refers to brands for which scoring is being performed by the system.

A related brand's scores are based on the brand's tree structure, not their own. Since two brands can vary so drastically, the comparison would be meaningless unless the metrics were compared using the same nodes, using the same share ratios. This aspect of the calculation forces that we do much of the calculation on-the-fly, rather than pre-compute the scores for quick retrieval when needed.

Referring back to FIG. 3, at block 320, service 120 performs an analysis of the score data and the data from which the scores were derived. For example, service 120 may compare the derived scores for the individual media channels against any number of factors including, for example, historical scores for the particular brand, scores for similarly sized businesses, scores for businesses in the same industry, scores for businesses that are in the same geographic location or area; and industry standard data.

Additionally at step 320, service 120 may compare the scores and underlying data values to benchmarks that have been established. As noted above at step 310, benchmarks and notification procedures may be established by users and/or the system for each media channel. For example, a business could set a threshold they want to achieve (i.e. 1500 website visitors in a month) or a percentage increase or decrease (i.e. alert me if my average time on site falls by 15%). The user can also set alerts related to how they are doing relative to their competitors (i.e. the user can be notified if their competitors are performing 20% better in certain metrics). For example, a business may establish a benchmark requiring notification when their score for a particular media channel reaches a new high or low or moves outside a desired range. The integration of benchmarks and notifications allows service 120 to operate as a watchdog for a business's most important metrics, and helps alert the business to any changes that need their attention.

The analysis performed at block 320 may also involve analyzing the particular data components that were received for the various media channels. Here too, the component data for a particular brand may be compared against the data items, for example, of competitors, similarly sized businesses, historical data, etc. Filters may be applied to the data in order to customize the reporting for each metric for the user. Examples of data items that are received from various media channels and which may be the subject of comparison for a brand include the following: unique visitors; average page views; new visitors; average time on site; conversion rates; click through rates; impression share; referrals; social strength (popularity); social sentiment (public opinion); social passion (how much individuals like you); social reach (your share of the media); unique authors; percentage engaged calls; percentage unanswered calls after hours; open rates; click through; number of subscribers; percentage shred/liked; open rates; number of subscribers; response rate; percentage shared/liked; CPL; site visits from traditional media.

According to still another aspect of the analysis that may be performed at step 320, service 120 is adapted to provide tips or suggestions to an operator based upon the analysis of its scores. As a consequence of aggregating data from several different sources of performance data, service 120 is able to learn about useful marketing strategies. Service 120 comprises data that indicates what marketing methods have historically worked and not worked for a business. Additionally, service 120 has access to data for similar businesses that may have stronger and/or weaker brand scores. As such, brand scoring service 120 might be viewed as a marketplace of important data, that is constantly changing over time as businesses evolve and alter their marketing efforts.

By reviewing certain performance indicators and accounts over time, and analyzing the data, the system may be used to analyze data and make educated recommendations to help improve a brand's faltering metrics. Based upon observations that are made over time, a rule base of best practices, tips, recommendations and tricks for particular performance indicators have been developed and stored as part of a rule base. For example, for the scoring of email services, service 120 comprises a large amount of data about email campaigns that are sent out—wording of email title, email title length, frequency of email campaign, segmentation, demographic targeting, etc. Based upon what has worked for other similar businesses, rules have been developed that encompass suggestions for improving scores. Furthermore, and in addition to including suggestions and tips, the rule base also contains predictive information. For example, associated with a suggested action may be an estimate of the likely improvement that might be expected from an action. For example, the rule base may specify that decreasing the length of a subject listed in an email campaign may result in a 10 to 20 percent increase in response rates. The system utilizes the rule base to provide the predictive feedback along with the suggestive feedback such as tips. The system utilizes historical and other business-specific data to generate the rule base and thereby predict future performance. Based upon trends as well as psychographic, demographic, and geographic data, the system makes predictions and creates future benchmarks.

In a particular scenario, if a score is determined by the system to be low or to fall below a predetermined value, the system refers to its rule base which includes actions that might result in an improvement to the score. In an example scenario, the score derived by the system for a particular brand may be below a desired benchmark. The system may refer to the rule base, which may be stored in database 142, to derive a tip for the particular brand. For example, the rule base may indicate that companies in a particular industry have had success with running email campaigns focused at a particular demographic. In another scenario, the score derive by service 120 for a particular media channel may be below that of competitors. Service 120 may refer to its rule base and the data of competing businesses to determine that there is a correlation between a particular act and high scores. Accordingly, service 120 may identify as a tip or suggestion that the business with the less than desired score take the particular action.

Analysis performed by service 120 may further involve providing updates regarding events relating to a particular media channel or source as the events happen. The event data may be thought of as being gathered and prepared for display on a repetitive basis. In an example scenario, a user may “checks-in” on Facebook at a business location. This event will be reflected in the data that is received from the Facebook data and which is ultimately displayed with the media feed. By way of further example, if someone calls a tracking number that has been associated with a business, and call tracking is included in the media types that are being received, the recently received call will be reflected in data that is displayed for the particular feed. Still further, in the scenario that a click-through on email is included in a data feed for a media channel, the click-through may be updated in the information that is presented to the users. Both online and offline marketing efforts can be combined and placed into feeds that may be reflected in the user interface. There are many groups of data for which updated data is received and which might be repeatedly updated on a user interface. Some of the media channels and corresponding data items that might be received and updated on a user interface include the following: Facebook with data items reflecting writing on the wall, comments, like, checkin, and tagging; Twitter with data items reflecting new followers, retweeting, and @tagging; Telephone calls with data items representing that a tracking number was called; Email with data items indicating whether an email was opened; clicked on; passed on; or unsubscribed; Web features including whether a form was filled out; Foursquare/gowalla with data items reflecting location check-in; Blogs with data items indicating comments on the blog and the number of blog followers; Yelp with data items indicating a review has been placed; Flikr, Picasa, and Photobucket with data items indicating a photo is posted with a particular keyword tag; and Youtube with data items indicating a comment was made on a video and that users are following the business.

It should be appreciated that in addition to performing analysis for scores and data associated with the individual media channels, analysis will also be performed at the aggregate score level as well.

At block 322, brand scoring service 120 stores data that has been received from media channels as well as data relating to its analysis. In an example embodiment, the data may be stored in database 142. The stored data may be constantly modified and added to and is always available for communication to users of the system. As noted in the above discussion, tree memory structures may be employed to represent data in the system. Transferring data up a tree, consisting of potentially hundreds of accounts' worth of data, is daunting. Preferably, the system has the ability to quickly search and divide up data when performing the calculations. If the system tried to perform a separate database query each time it did another calculation, the performance would significantly drop. In order to avoid hitting the database many times, the metrics needed for all calculations may be grabbed in a single, elaborate SQL query.

In one example embodiment, once the data is retrieved, it may be stored in a data structure that allows data to be quickly retrieved and categorized. Internally, it is represented using an n-dimensional lookup table. Every value in the lookup table has a unique set of keys for each dimension. No two values share the same key. Each dimension in a key is called a key part, which is single value. The table supports dividing its values up by key parts.

In an example embodiment, the following dimensions are used to store metric values: Date, Comparison Type, Time Unit, Metric Definition and Account. The value table does not exist for very long; it is used to generate a score table. The score table is generated by splicing the value table, first by metric, then by comparison, then by time unit, then by account. The remaining splices have a single dimension, date, which is sorted and then enumerated to generate percentiles on a daily basis. If the account is the account the score is being calculated for, an additional percentile is calculated for each comparison type.

Each percentile that may be calculated is stored in a score table, with the following dimensions: Date, Comparison Type, Metric Definition and account. Notice that the time unit dimension does not exist. The time unit is only used to enforce data is compared within the same time unit; afterwards, it serves no purpose.

In an example embodiment, the lookup tables may contain gaps. When aggregating scores up the tree, these gaps can be detected to determine whether a node contributes to the brand score, for a particular date, and also allows scores to be carried forward.

In an example embodiment, each node in the tree has its own copy of a score table. This allows a score to be calculated for any node in the tree. In order to move data up the tree, the lookup tables support a merge function, which simply combines the key/value pairs in one table with that of another. Duplicates are considered an error.

At the end of the calculation, the score tables can be divided up again by account. The main account will have historic scores associated with the history comparison type dimension. The other comparison type dimensions will hold how the account performed compared to the industry standards. For the other accounts, there will only be historic scores.

Scores may be generated by collapsing down the dimensions to just the date dimension. Collapsing down a dimension means aggregating the values sharing the same dimension key part value. How the values are aggregated, depends on the dimension. For instance, collapsing the comparison type dimension means taking the weighted average of the historic and other comparison scores. The metric definition dimension is collapsed by summing the metric contributions (which is the result of multiplying the percentile, share ratio and 550).

In an example embodiment, lookup tables may immutable. This means operations such as merging, collapsing and splicing result in new tables being created. This technique allows sharing between tables without the risk of changes to one table unexpectedly affecting another. This also allows actions to be performed on a table without first needing to make a copy. The keys used at the top of the tree are the same as those at the bottom of the tree.

At block 324, brand scoring service 120 communicates data to the users. The data may be communicated in any format and through any medium that is desired. In an example scenario, the data may be communicated using a web interface. The data that is available to be communicated includes, for example, the scores that have been derived for the various media channels as well as any additional analysis of the received data for each of the media channels. For example, the results of any comparisons that were made of the scores and/or the underlying data is presented to the user. Likewise any updates to the data that is received from the media channels may be automatically pushed out and reflected in the data presented to users. In some instances, the data may be presented in a particular visual context such as a map or graph illustrating aggregate data and/or values as a function of time. Such a format allows users to view historical trends. In some embodiments, data corresponding to, for example, comments, activity, and actions, may be represented on a map to signify the geographic location of the customers responsible for the particular activity. Still further, data reflecting both positive and negative feedback as indicated by call transcription, web submissions, and social comments are presented and may be compared to similar data for other businesses.

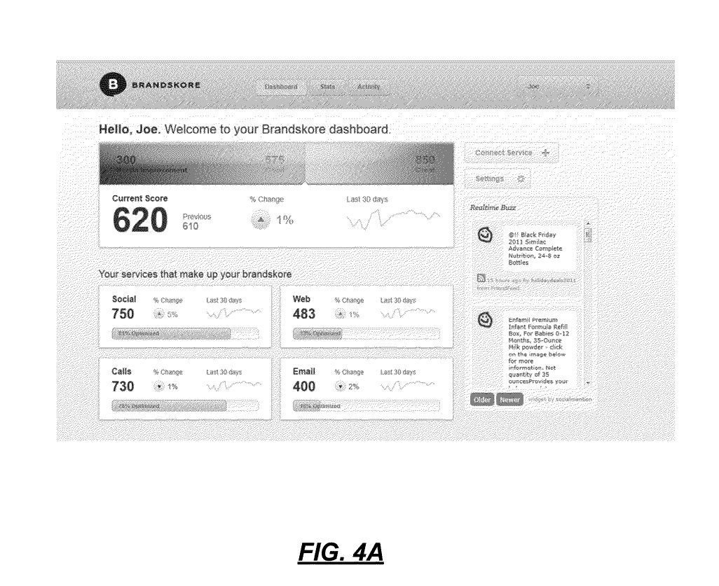

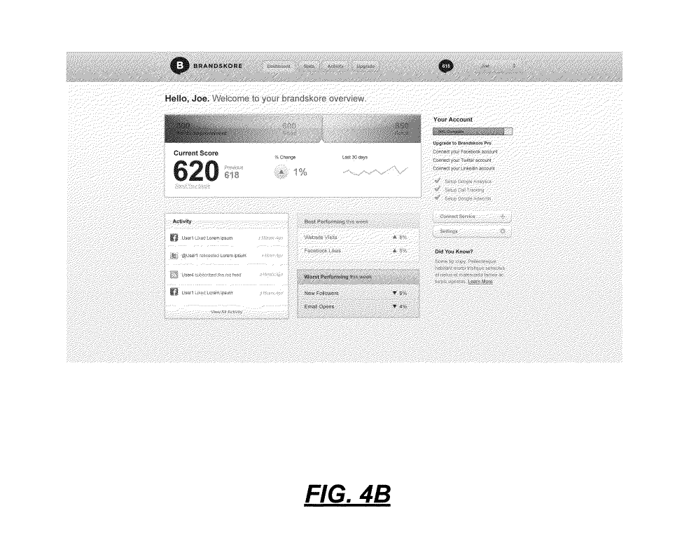

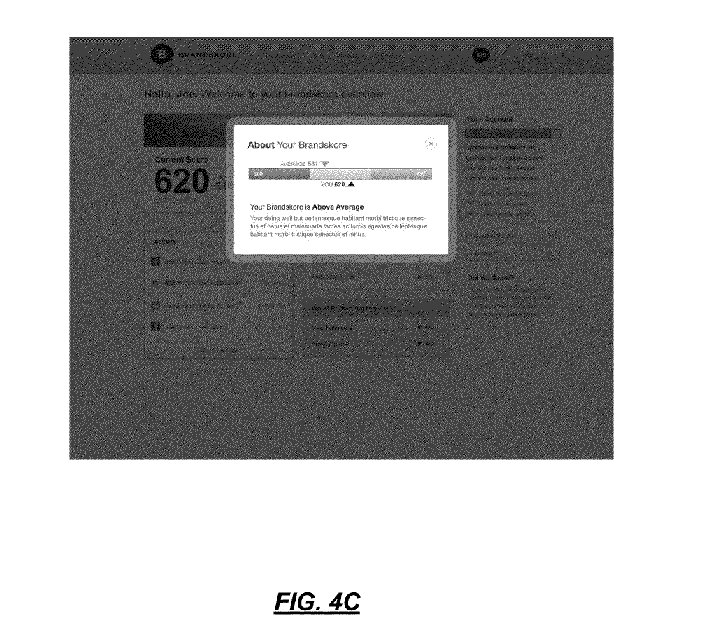

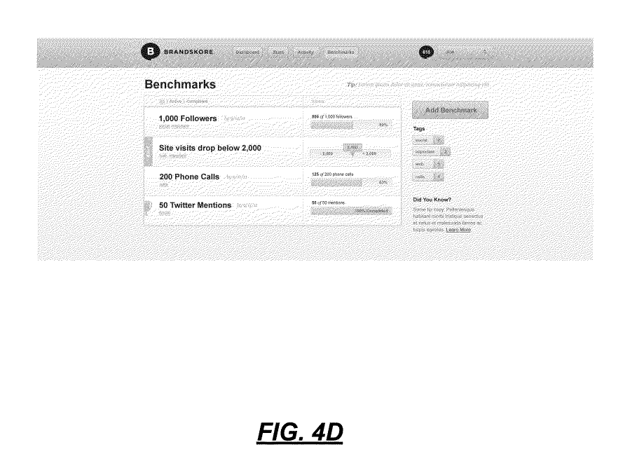

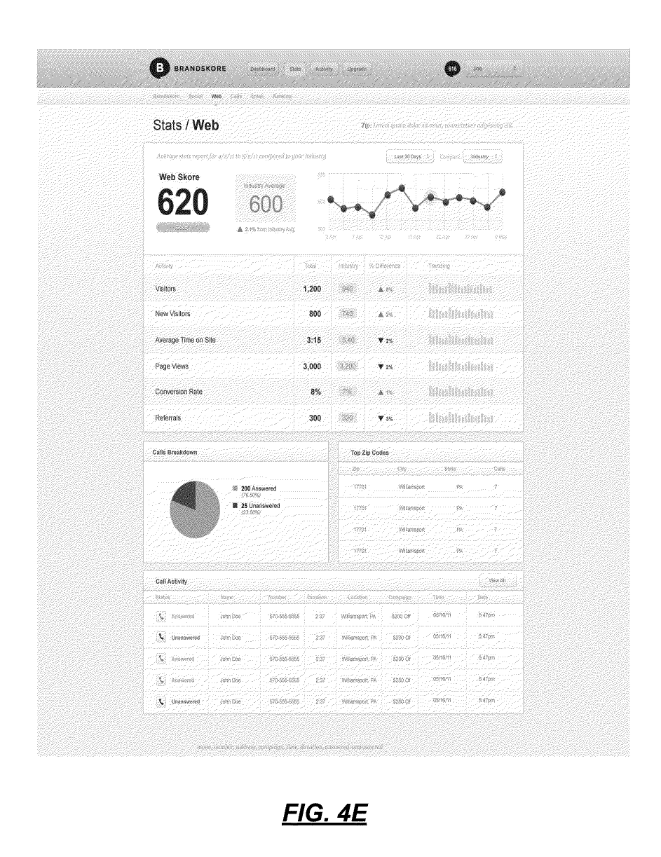

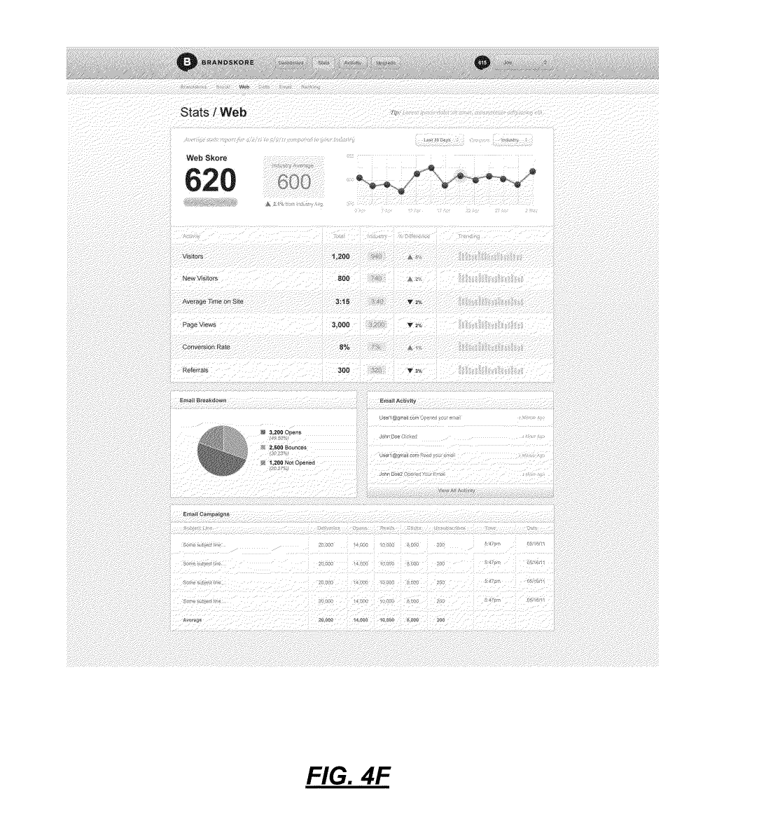

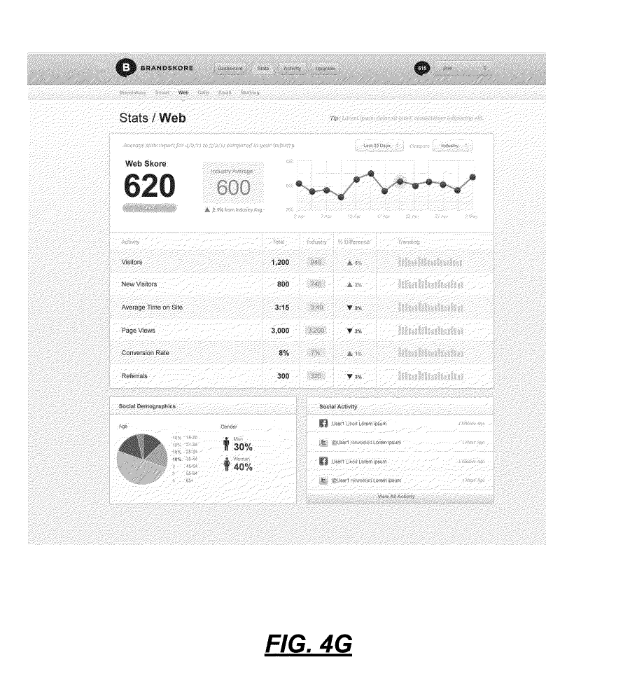

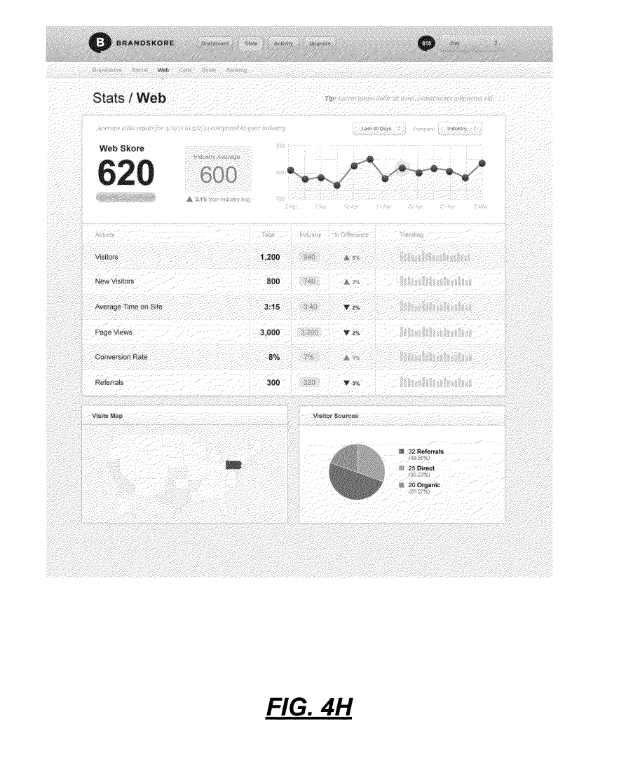

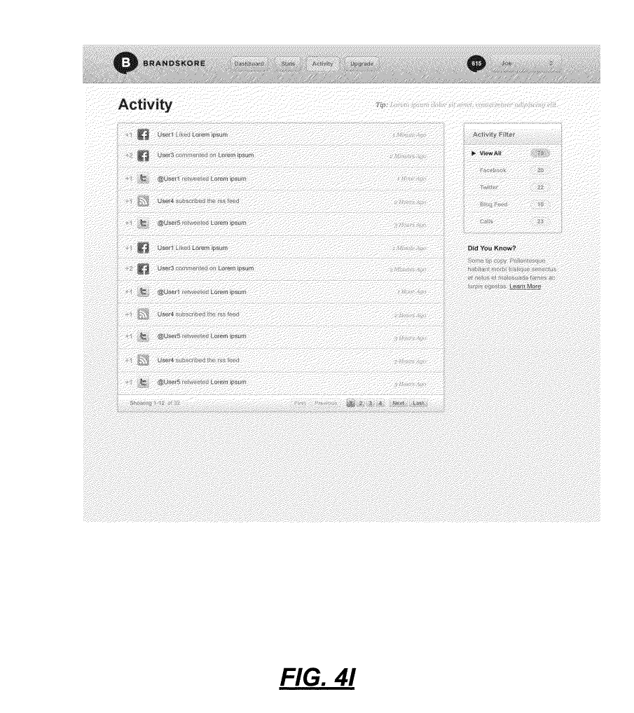

FIGS. 4A through 4I depict example user interface screens that may be generated by brand scoring service 120 for purposes of presenting data to users. FIG. 4A depicts a user interface providing an overview of a user's/business's brand score. As illustrated, an overall or aggregate score is presented for the brand along with the scores for the four media channels—social, web, calls, and email—upon which the aggregate score is based. For each of the aggregate score and the individual media type scores, a percentage change is included along with a chart of the score over the past 30 days. This information provides the operator with information indicating the historical and recent trends of the score. The interface also may provide recently issued news information relevant to the particular brand.

FIG. 4B depicts a user interface that highlights relevant activity and analysis of recent scoring trends. In the particular example, below the overall score are listed recent activity from the various media channels relevant to the particular brand. Also displayed are the results of an analysis to determine the best and worst performing media channel data items. In this particular example, website visits and Facebook likes have improved while new Facebook followers and email openings have fallen off

FIG. 4C depicts a user interface illustrating a relative comparison that may be presented. In particular, the brand score is presented along with the average score for similarly situated businesses. In this particular example, the brand score is above the average score for similarly situated businesses.

FIG. 4D depicts a user interface illustrating benchmarks that may have been established for the particular brand. As shown, in an example embodiment service 120 may allow for establishing benchmarks for data items such as the number of Facebook followers, the number of web site visitors, the number of phone calls that are received in response to an add, and the number of mentions on Twitter. As illustrated in FIG. 4D, service 120 will track and display the progress reflected in the actual data relative to any benchmarks that may have been established.

FIGS. 4E through 4I depict user interfaces that present detailed information about the data that has been collected and analyzed from various media channels. In FIG. 4E, the user interface reflects information collected for a particular web page. As shown, various information that has been collected for the web site such as the number of visitors, the number of new visitors, the average time on the site, the number of page views, the percentage of visitors that were converted to customers, and the number of referrals are shown. For each data item, an industry standard is presented along with a relative difference. Trend data is presented for each category of information. The user interface further comprises detailed analysis of telephone calls that may have been received as a result of a particular web site including, for example, the top zip codes from which calls were placed, the relative number of calls that were answered and not answered, and a listing of recent call activity. As service 120 collects data, it updates the user interface to reflect the recent data. For example, if recent call activity is received by service 120 from the media channel, that user interface will be updated to reflect the recent call activity.

FIG. 4F presents an example user interface screen similar to that of FIG. 4E, although FIG. 4F further comprises detailed analysis of emails that may have been received in connection with a particular web site. For example, FIG. 4F includes detailed information about the number of emails in an email campaign that have been opened, not opened, and bounced. Recent openings of emails by particular individuals may be displayed.

FIG. 4G present an example user interface screen similar to that of FIG. 4E and 4F, although FIG. 4G further comprises detailed analysis of inputs relevant to social networking services. In the particular example, a breakdown of the social demographics of individuals who may have interacted with a particular brand as represented by a website is presented. Recent activity from social networking services are also illustrated including inputs from Facebook and Twitter.

FIG. 4H present an example user interface screen similar to that of FIG. 4E and 4F, although FIG. 4H provides detailed information about visitors to a web site. In particular, FIG. 4H depicts a geographic location of the visitors to a site and an indication of whether the visitors came by way of referral or otherwise.

FIG. 4I presents an example user interface that provides detailed information regarding data that was collected from relevant social networking services. In particular, recent activity relative to the brand from Facebook and Twitter is illustrated.

Example Computing Environment

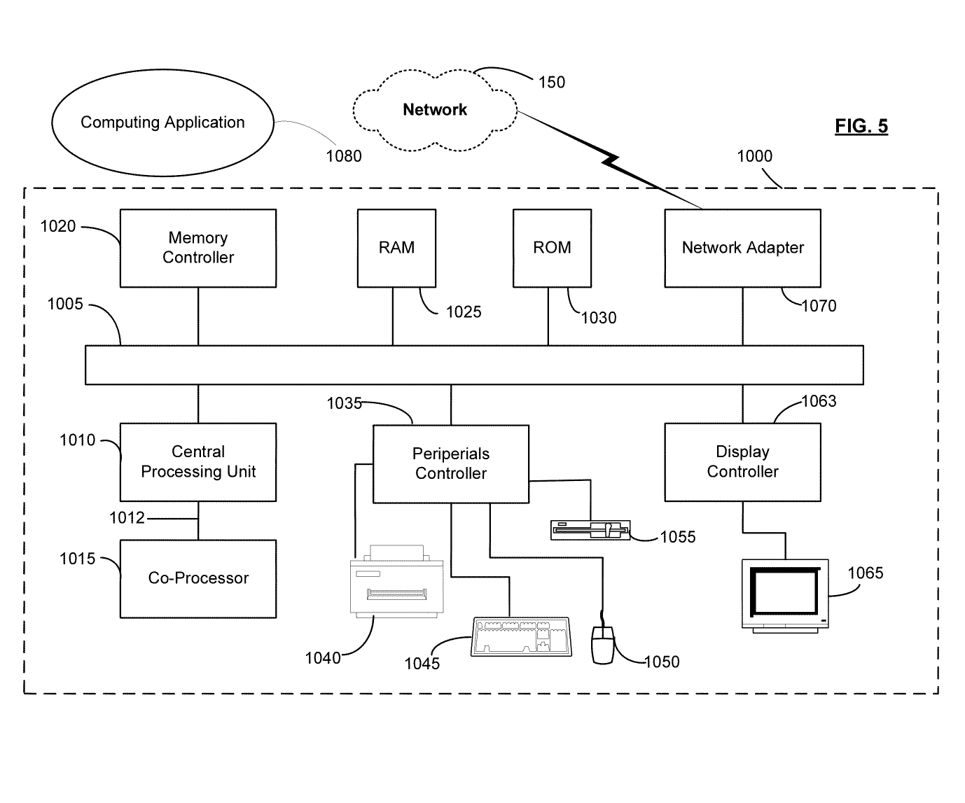

FIG. 5 depicts a block diagram of an exemplary computing system 1000 that may be used to implement the systems and methods described herein. For example, the computing system 1000 may be used to implement the brand scoring service 120 as well as any of devices 110a-e and 112a-c. The computing system 1000 may be controlled primarily by computer readable instructions that may be in the form of software. The computer readable instructions may include instructions for the computing system 1000 for storing and accessing computer readable instructions themselves. Such software may be executed within a central processing unit (CPU) 1010 to cause the computing system 1000 to perform the processes or functions associated therewith. In many known computer servers, workstations, personal computers, or the like, the CPU 1010 may be implemented by micro-electronic chips CPUs called microprocessors.

In operation, the CPU 1010 may fetch, decode, and/or execute instructions and may transfer information to and from other resources via a main data-transfer path or a system bus 1005. Such a system bus may connect the components in the computing system 1000 and may define the medium for data exchange. The computing system 1000 may further include memory devices coupled to the system bus 1005. According to an example embodiment, the memory devices may include a random access memory (RAM) 1025 and read only memory (ROM) 1030. The RAM 1025 and ROM 1030 may include circuitry that allows information to be stored and retrieved. In one embodiment, the ROM 1030 may include stored data that cannot be modified. Additionally, data stored in the RAM 1025 typically may be read or changed by CPU 1010 or other hardware devices. Access to the RAM 1025 and/or ROM 1030 may be controlled by a memory controller 1020. The memory controller 1020 may provide an address translation function that translates virtual addresses into physical addresses as instructions are executed.

In addition, the computing system 1000 may include a peripherals controller 1035 that may be responsible for communicating instructions from the CPU 1010 to peripherals, such as, a printer 1040, a keyboard 1045, a mouse 1050, and data a storage drive 1055. The computing system 1000 may further include a display 1065 that may be controlled by a display controller 1063. The display 1065 may be used to display visual output generated by the computing system 1000. Such visual output may include text, graphics, animated graphics, video, or the like. The display controller 1063 may include electronic components that generate a video signal that may be sent to the display 1065. Further, the computing system 1000 may include a network adaptor 1070 that may be used to connect the computing system 2000 to an external communication network such as the network 150, described above in FIG. 1.

Thus, applicants have disclosed exemplary embodiments of systems and methods for scoring and analyzing the strength and weakness of brands. The disclosed system allows users to compile, analyze, and score all of their media channels and marketing accounts and data in one place. The system provides for connecting to third party data sources such as email, call tracking, social media, etc. and retrieving relevant data relating to the strength or weakness of a brand. The system allows for comparing key performance indicators and provides charts and graphs for doing so. The disclosed system compares data from across multiple data segments, and generates scores that are constantly updated to reflect changes in how their business and brand are perceived. The disclosed service allows the user to set benchmarks for reminders and alerts and then monitors activity and statistics and reports the important numbers to the user.

It will be appreciated that while illustrative embodiments have been disclosed, the scope of potential embodiments is not limited to those explicitly set out. For example, while the system has been described with reference to systems and methods for particular media types, the envisioned embodiments extend beyond processing of any particular media type. Similarly, any type of user input or lead, beyond telephone calls or URL accesses, that results from an advertisement may be tracked using the disclosed service.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Those skilled in the art will appreciate that the disclosed embodiments may be provided as a subscription web based solution that anyone with an internet connection may log on and begin using the system. Large corporations may internally monitor multiple users within an exemplary embodiment platform to direct media placement. The potential embodiments may be developed and programmed in any web based technology platform. Alternatively, a potential embodiment may be implemented as a stand alone application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, implemented by a computing system, for analyzing brand awareness, comprising:
receiving a first data set relating to a brand, the first data set associated with a first communication medium;
receiving a second data set relating to the brand, the second data set associated with a second communication medium;
deriving using the first data set a first score relating to the brand and associated with the first communication medium;
deriving using the second data set a second score relating to the brand and associated with the second communication medium; and
deriving an aggregate score relating to the brand using the first score and the second score.

2. The method of claim 1, further comprising requesting data relating to the brand from first communication medium and the second communication medium.

3. The method of claim 1, wherein receiving a first data set relating to a brand, the first data set associated with a first communication medium comprises receiving a data set associated with one the following: a web site; a social application; telephone conversations; email; broadcast media; mobile applications; and landing pages.

4. The method of claim 1, wherein receiving a second data set relating to a brand, the first data set associated with a first communication medium comprises receiving a data set associated with one the following: a web site; a social application; telephone conversations; email; broadcast media; mobile applications; and landing pages.

5. The method of claim 1, further comprising analyzing the first score relative to scores for at least a second brand associated with the first communication medium.

6. The method of claim 5, wherein analyzing the first score relative to scores for at least a second brand associated with the first communication medium comprises comparing the first score to one or more of the following: scores for similarly sized businesses; scores for businesses in the same industry; scores for businesses in a particular geographic area; scores for a particular industry.

7. The method of claim 1, further comprising analyzing the second score relative to scores for at least a second brand associated with the first communication medium.

8. The method of claim 7, wherein analyzing the second score relative to scores for at least a second brand associated with the first communication medium comprises comparing the first score to one or more of the following: scores for similarly sized businesses; scores for businesses in the same industry; scores for businesses in a particular geographic area; and scores for a particular industry.

9. The method of claim 1, further comprising comparing data items in the first data set relating to the brand with data items corresponding to one or more of the following: competitors; similarly sized businesses; a particular industry; and historical data.

10. The method of claim 9, wherein comparing data items in the first data set relating to the brand comprises comparing data items relating to one or more of the following: unique visitors; average page views; new visitors; average time on web site; conversion rates; click through rates; impression share; referrals; social strength; social sentiment; social passion; social reach; unique authors; percentage engaged calls; percentage unanswered calls after hours; open rates; click through; number of subscribers; percentage shared; open rates; number of subscribers; response rate; site visits directed from traditional media.

11. The method of claim 1, further comprising comparing data items in the second data set relating to the brand with data items corresponding to one or more of the following: competitors; similarly sized businesses; a particular industry; and historical data.

12. The method of claim 11 wherein comparing data items in the second data set relating to the brand comprises comparing data items relating to one or more of the following: unique visitors; average page views; new visitors; average time on web site; conversion rates; click through rates; impression share; referrals; social strength; social sentiment; social passion; social reach; unique authors; percentage engaged calls; percentage unanswered calls after hours; open rates; click through; number of subscribers; percentage shared; open rates; number of subscribers; response rate; site visits directed from traditional media.

13. The method of claim 1, further comprising repeatedly receiving data associated with the first communication medium and presenting updates regarding events associated with the first communication medium.

14. The method of claim 1, wherein presenting updates regarding events associated with the first communication medium comprises presenting updates regarding user inputs received at the first communication medium.

15. The method of claim 1, further comprising comparing the first score relative to benchmarks and communicating a notification depending upon the comparison.

16. A computing system adapted for performing brand analysis, comprising:
a computing processor;
computing memory communicatively coupled with the computing processor, the computing memory comprising instructions that when executed by the computing system cause the computing system to perform operations comprising:
receiving data relating to a brand from a plurality of media sources, the plurality of media sources corresponding to both on-line media and off-line media;
analyzing the received data to derive for each of the plurality of media sources a score relating to the brand;
generating an aggregate score for the brand using the derived score for each of the plurality of media sources.

17. The system of claim 16, wherein receiving data relating to a brand from a plurality of media sources comprises receiving data relating to advertisements that have run in both traditional media and on-line media.

18. The system of claim 16, wherein analyzing the received data to derive for each of the plurality of media sources a score relating to the brand comprises processing data received from each of the media sources to be compatible with other received data.

19. The system of claim 16, wherein analyzing the received data to derive for each of the plurality of media sources a score relating to the brand comprises comparing data received for each of the media sources to data for similar brands.
